(19) United States
(12) Patent Application Publication
(10) Pub. No.: US 2006/0020514 A1
(43) Pub. Date: Jan. 26, 2006

(54) Method and system for aggregating multiple prescription claims

(76) Inventor: Paul Yered, Thousand Oaks, CA (US)

Correspondence Address: MCDERMOTT WILL & EMERY LLP;Suite 3400, 2049 Century Park East, Los Angeles, CA, 90067, US

(21) Appl. No.: 11/187,547

(22) Filed: Jul. 22, 2005

Related U.S. Application Data
(60) Provisional application No. 60/590,900, filed on Jul. 23, 2004.
(60) Provisional application No. 60/600,708, filed on Aug. 10, 2004.
(60) Provisional application No. 60/615,449, filed on Oct. 1, 2004.
(60) Provisional application No. 60/625,820, filed on Nov. 8, 2004.
(60) Provisional application No. 60/628,505, filed on Nov. 15, 2004.
(60) Provisional application No. 60/642,028, filed on Jan. 7, 2005.
(60) Provisional application No. 60/644,091, filed on Jan. 14, 2005.
(60) Provisional application No. 60/646,467, filed on Jan. 24, 2005.
(60) Provisional application No. 60/662,721, filed on Mar. 17, 2005.
(60) Provisional application No. 60/684,446, filed on May 25, 2005.

(51) Int. Cl. G06Q 30/00

(52) U.S. Cl. 705/14; 705/26

(57) ABSTRACT

A system for reducing prescription costs includes a claims processing subsystem that receives and process prescription claims from pharmacies and/or employers and/or other parties or entities, who unify their prescription claims. The prescriptions claims are for drugs made by multiple manufacturers. The received claims are aggregated and sorted by manufacturer. Manufacturer rebates are received from each manufacturer, based on the aggregated claims for that manufacturer. The manufacturer rebates are allocated and distributed to each party or entity, based on the portion of the manufacturer rebates that are attributable to the claims that are received from that party or entity.

### CROSS-REFERENCE TO RELATED APPLICATIONS

This application is based upon, and claims the benefit of priority under 35 U.S.C. § 119(e) from, U.S. Provisional Patent Application Ser. No. 60/590,900, filed Jul. 23, 2004, entitled “System and Method for Reducing Prescription Costs,” attorney docket no. 71737-011; U.S. Provisional Patent Application Ser. No. 60/600,708, filed Aug. 10, 2004, entitled “Advanced System and Method for Reducing Prescription Costs,” attorney docket no. 71737-012; U.S. Provisional Patent Application Ser. No. 60/615,449, filed Oct. 1, 2004, entitled “Computer Operating System to Reduce Prescription Costs, Including Remote Prescription Order Fulfillment,” attorney docket no. 71737-013; U.S. Provisional Patent Application Ser. No. 60/625,820, filed Nov. 8, 2004, entitled “Remote Prescription Order Fulfillment and In-Room Pharmacy at Reduced Costs,” attorney docket no. 71737-014; U.S. Provisional Patent Application Ser. No. 60/628,505, filed Nov. 15, 2004, entitled “Method and System to Lower Prescription Costs,” attorney docket no. 71737-015; U.S. Provisional Patent Application Ser. No. 60/642,028, filed Jan. 7, 2005, entitled “Method and System for Reducing Drug Costs,” filed under attorney docket no. 71737-017; U.S. Provisional Patent Application Ser. No. 60/644,091, filed Jan. 14, 2005, entitled “Retail Pharmacy Prescription Management Coalition (RPPM) USA's Rebate System,” attorney docket no. 71737-019; U.S. Provisional Patent Application Ser. No. 60/646,467, filed Jan. 24, 2005, entitled “System and Method for Reducing Drug Costs by the Coalition of Manufacturer Rebates,” attorney docket no. 71737-020; U.S. Provisional Patent Application Ser. No. 60/662,721, filed Mar. 17, 2005, entitled “System and Method for Reducing Drug Costs,” attorney docket no. 71737-022; and U.S. Provisional Patent Application Ser. No. 60/684,446, filed May 25, 2005, entitled “Improved System and Method For Reducing Drug Costs: Retail Pharmacy Prescription Management (RPPM) Coalition,” attorney docket no. 71737-024. The contents of all of these applications are incorporated herein by reference in their entirety as though fully set forth.

### BACKGROUND

Prescription claims may typically be processed through PBMs (Prescription Benefit Managers), which may be claims processing organizations or insurance companies. The pricing method for prescription drugs that is used by most PBMs may be based upon an average wholesale price of the drugs, which may be an industry standard, but which may include an extremely steep mark-up, compared to the price the wholesaler actually paid the drug manufacturer.

For brand name drugs, the escalated prescription drug prices, computed based on the industry standard average wholesale pricing, may be about 20% to about 30% higher than the actual cost to the wholesaler of the drugs. For generic drugs, the artificially inflated average wholesale prices may range from about 80% up to 1000% higher, compared to the actual cost of the generic drugs. Such high prices may include claims processing rebates, which may have been paid to the PBMs by the manufacturers, but which may not be based on any actual sale of the drugs.

For these reasons, there is a need for systems and methods of reducing prescription costs.

### SUMMARY

A system for reducing prescription costs may include a processing system configured to receive and process claims from multiple pharmacies for prescriptions made by multiple manufacturers. The processing system may be further configured to aggregate the received claims for the prescriptions made by each manufacturer, to obtain from each manufacturer a manufacturer rebate based on the aggregated claims for that manufacturer, and to allocate and distribute a pharmacy rebate to each pharmacy. Each pharmacy rebate may be based on the portion of the manufacturer rebates that is attributable to the claims that are received from the pharmacy.

A system for reducing prescription costs may include a processing system configured to receive and process, on behalf of multiple employers, claims from multiple pharmacies for prescriptions made by multiple manufacturers, the processing system further configured to aggregate the received claims for the prescriptions made by each manufacturer, to obtain from each manufacturer a manufacturer rebate based on the aggregated claims for that manufacturer, and to distribute a rebate to each employer. Each rebate may be allocated based on the portion of the manufacturer rebates that is attributable to the claims that are received on behalf of that employer.

A system for reducing prescription costs may include means for receiving claims from multiple pharmacies for prescriptions made by multiple manufacturers, and means for storing the received claims. The system may further include means for aggregating the claims in the database for the prescriptions made by each manufacturer. The system may further include means for obtaining a manufacturer rebate from each manufacturer based on the aggregated claims for that manufacturer. The system may further include means for allocating and distributing a pharmacy rebate to each of the pharmacies, each pharmacy rebate based on the portion of the manufacturer rebates that are attributable to the claims that are received from that pharmacy.

A system for reducing prescription costs may include a claims processing subsystem configured to receive and process claim information about a first set of claims from multiple pharmacies, and about a second set of claims from multiple pharmacies. The first set of claims may be for prescriptions made by multiple manufacturers including at least one claim for a prescription made by a first manufacturer, and may have been previously received by a first claims processing organization. The second set of claims may be for prescriptions made by multiple manufacturers including at least one claim for a prescription made by the first manufacturer, and may have been previously received by a second claims processing organization.

The system may further include a rebate subsystem configured to aggregate the claim information for the prescriptions made by each manufacturer, to obtain from each manufacturer a manufacturer rebate based on the aggregated claim information for that manufacturer, and to allocate and distribute a rebate in connection with each of the claims, based on the portion of the manufacturer rebates that is attributable to the claim.

A method of reducing prescription costs may include receiving claims from multiple pharmacies for prescriptions made by multiple manufacturers, and aggregating the received claims for the prescriptions made by each manufacturer. The method may include obtaining a manufacturer rebate from each manufacturer, based on the aggregated claims for that manufacturer. The method may include allocating and distributing a pharmacy rebate to each of the pharmacies, each pharmacy rebate being based on the portion of the manufacturer rebates that are attributable to the claims that are received from the pharmacy.

A system for reducing prescription costs includes a processing system configured to receive and process claims from multiple pharmacies for prescriptions made by multiple manufacturers. The processing system is further configured to aggregate the received claims for the prescriptions made by each manufacturer, to obtain from each manufacturer a manufacturer rebate based on the aggregated claims for that manufacturer, and to allocate and distribute a pharmacy rebate to each pharmacy. Each pharmacy rebate may be based on a portion of the manufacturer rebates.

A system for reducing prescription costs includes a processing system configured to receive and process claims from multiple parties for prescriptions made by multiple manufacturers. The processing system is further configured to aggregate the received claims for the prescriptions made by each manufacturer, to obtain from each manufacturer a manufacturer rebate based on the aggregated claims for that manufacturer, and to allocate and distribute a rebate to each party, each rebate being based on a portion of the manufacturer rebates.

The following detailed description of illustrative embodiments and the accompanying drawings set forth the features summarized above, as well as other features and benefits.

### BRIEF DESCRIPTION OF THE DRAWINGS

FIG. 1 is a schematic diagram of a system for lowering prescription costs by consolidating and aggregating prescription claims.

FIG. 2 is a conceptual diagram illustrating a flow of operations that may occur between different entities, in one embodiment of methods and systems in which prescription costs are lowered by aggregating claims and by obtaining manufacturer rebates based on the aggregated claims.

FIG. 3 is another conceptual diagram illustrating a flow of operations that may occur between different entities, in another embodiment of methods and systems in which prescription costs are lowered by aggregating claims and obtaining manufacturer rebates based on the aggregated claims.

FIG. 4 is a conceptual diagram illustrating a system and method for lowering prescription costs through individual drug benefit plans implemented by individual pharmacies and/or employers, in competition with outside benefit plans.

### DETAILED DESCRIPTION

Methods and systems are described for lowering the cost of prescription drugs by aggregating and consolidating multiple prescription claims. As described below, these methods and systems allow pharmacies, employers, and other purchasers of prescription drugs to unify and consolidate their prescription claims, thereby substantially lowering prescription costs due to the resulting increase in market share.

In one embodiment of the systems and methods described below, prescription costs may be lowered by obtaining manufacturer rebates based on aggregated prescription claims. In another embodiment of the systems and methods described below, prescription costs may also be lowered by replacing an average wholesale pricing method, standard in the industry, with a formula based on the real cost of prescription drugs. In a further embodiment of the systems and method described below, prescription costs may also be lowered by estimating the rebates that are expected to be paid by manufacturers to PBMs (prescription benefit managers), then incorporating the projected rebates into the wholesale acquisition cost of the drugs. In yet another embodiment of the systems and methods described below, prescription costs may be lowered through individual drug benefit plans implemented by individual pharmacies and/or employers, in competition with outside benefit plans.

Manufacturer Rebates Based on Aggregated Claims

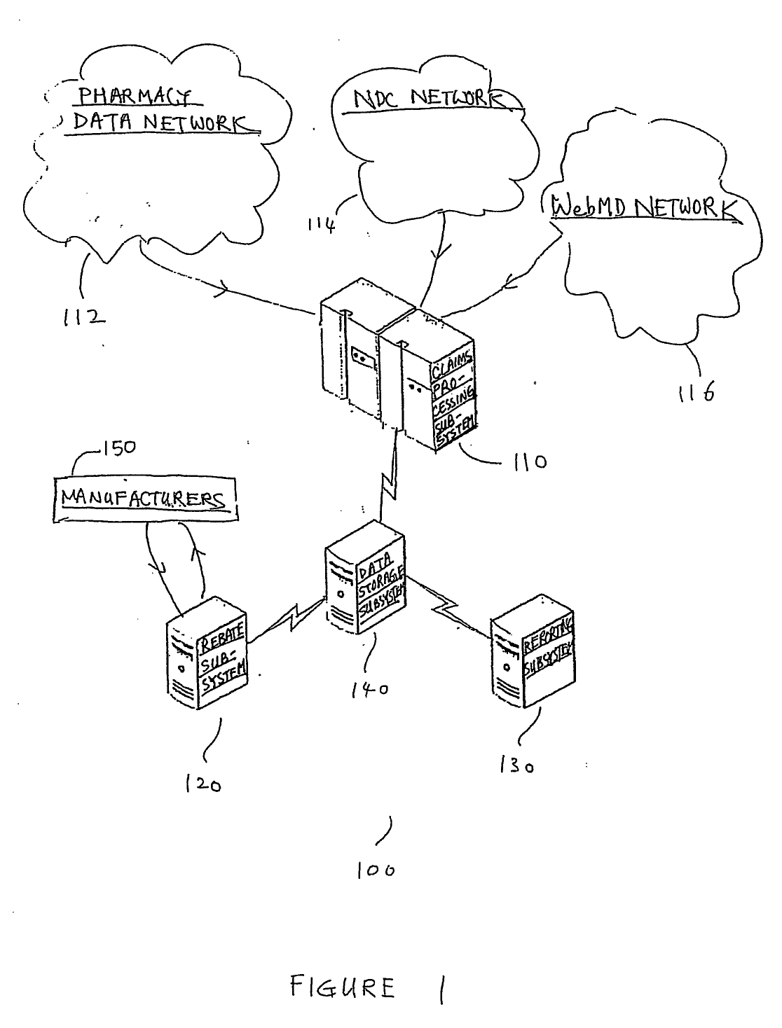

FIG. 1 is a schematic block diagram of a system 100 for lowering prescription costs by consolidating and aggregating prescription claims. In overview, the system 100 includes a claims processing subsystem 110, a rebate subsystem 120, and a data storage subsystem 140. The claims processing subsystem 110 may receive and process claims from many pharmacies, for prescription drugs that are made by many manufacturers of the drugs, e.g. by many drug companies. The received claims may be stored in the data storage subsystem 140. The rebate subsystem 120 may aggregate the claims in the data storage subsystem 140 for the prescriptions made by each manufacturer, and may allocate and distribute rebates to each of the pharmacies, based on the portion of the manufacturer rebates that are attributable to the claims received from each pharmacy.

In one embodiment, a unified and centralized system may be provided to allow most or all of the retail pharmacies and employers in the U.S.A. to combine and unify their prescription claims transmissions, in order to distribute the rebates (which increase in size as a result of such combination and aggregation) to the consumers, the pharmacies, and the employers. Such a system may be called the RPPM (Retail Pharmacy Prescription Management) system, and the method of lowering prescription costs through such a unified and centralized system may be called the RPPM method.

The subsystems within the RPPM system 100, including but not limited to the data storage center or subsystem 140 that stores the consolidated and unified claims data, the claims processing subsystem 110, and the rebate subsystem 120 may be configured to communicate with each other through one or more communications networks, including but not limited to the internet, a LAN (Local Area Network), a WAN (Wide Area Network), a VPN (Virtual Private Network), or any combination thereof.

Although the embodiment illustrated in FIG. 1 shows the claims processing subsystem 110 and the rebate subsystem 120 as separate computers, it should of course be understood that in some embodiments, both of these subsystems may reside and function within a single machine or module that has a single processor. In such embodiments the claims processing subsystem 110 and the rebate subsystem 120 may be part of a single processing system. In yet other embodiments, more than two machines or processors may be used to perform the functions of the claims processing subsystem and the rebate subsystem.

The RPPM system may generate increased rebates, because the combination of up to billions of prescriptions per year, approximately one-half of which may be brand name drugs equivalent to billions of brand name claims, may typically generate a larger market share rebate, compared to market share rebates generated by any one claims processing organization. These rebates may be distributed to employers, pharmacies, employees, consumers (both insured and non-insured), the poor, and the elderly, as well as to charity rebate funds or to drug and disease research organizations such as the cancer foundation.

In the present disclosure, the term rebate shall mean the return of at least some portion of the consideration already paid (or agreed to be paid) for a transaction (e.g. sale of drug), after the consummation of the transaction.

The initial act in implementing the RPPM method may be forming a coalition of pharmacies and their prescription claims. The claims processing subsystem 110 may be connected to the multiple pharmacies through a distributed, interoperable network such as the internet or any other type of communications networks described above. In the embodiment illustrated in FIG. 1, for example, the claims processing subsystem 110 is connected to many pharmacies through a pharmacy data network 112, and is also connected to the switch companies NDC (National Drug Classification) and WebMD Corporation (henceforth “WebMD”), through networks referred to as the NDC network 114 and the WebMD network 116 in FIG. 1.

The data storage subsystem 140 in the RPPM may be used to form a large aggregate or combination of all pharmacy prescription claims. The rationale may be that the more claims processed and stored, the larger the amount of rebates paid, when compared to the rebates paid by many separate combinations of claims processed through different insurance companies. In the case of a specific insurance company, the company would generate rebates based on that specific insurance company's collection of processed claims, which would be much smaller compared to the aggregate of claims processed through the RPPM. The large aggregate of pharmacy claims in the RPPM may thus be used to generate larger market share rebates and performance rebates from the drug manufacturers.

As described earlier, the received claims may be aggregated by the rebate subsystem 120 for the prescriptions made by each manufacturer, i.e. all of the received prescription claims are sorted by manufacturer. The rebate subsystem 120 may be connected (through various networks as described above) to many manufacturers, indicated in FIG. 1 through reference numeral 150. The rebate subsystem 120 may obtain a manufacturer rebate from each manufacturer, based on the aggregated claims for that manufacturer. In some embodiments, the rebate subsystem 120 may be configured to deliver a request to each one of manufacturers 150 for a manufacturer rebate based on the aggregated claims for that manufacturer, and to receive a manufacturer rebate from each manufacturer, in response to the request. The rebate subsystem 120 may allocate a pharmacy rebate to each pharmacy, based on a portion of the manufacturer rebates. In particular, the pharmacy rebate to each pharmacy may be allocated, based on the portion of the manufacturer rebates that is attributable to the claims that are received from the pharmacy. The rebate subsystem 120 may then distribute the pharmacy rebate to each pharmacy.

In some embodiments, the claims processing subsystem 110 may be configured to receive and process the prescription claims from the pharmacies, on behalf of multiple employers. In these embodiments, the rebate subsystem 120 may be further configured to allocate and distribute a rebate to each employer, based on a portion of the manufacturer rebates. In particular, the rebate to each employer may be allocated based on the portion of the manufacturer rebates that is attributable to the claim(s) that are received on behalf of that employer. Each employer may have one or more employees, and at least some of the claims received by the claims processing subsystem 110 may originate from one or more employees, i.e. may have been submitted by, or on behalf of, one or more employees. In these embodiments, the rebate subsystem 120 may be further configured to allocate and distribute a rebate to each of the employees, based on a portion of the manufacturer rebates. In particular, the rebate subsystem 120 may allocate the rebate to each employee, based on the portion of the manufacturer rebates that is attributable to the claims that are submitted by or on behalf of that employee.

In one embodiment (not shown), the rebate subsystem 120 may include a rebate aggregator (not shown) configured to aggregate the claims for the prescriptions made by each manufacturer, and a rebate administrator (not shown). In this embodiment, the rebate administrator may be configured to deliver a request to each manufacturer for a manufacturer rebate based on the aggregated claims for that manufacturer, to receive the manufacturer rebate in response to the request to the manufacturer, and to allocate and distribute a pharmacy rebate to each pharmacy. In this embodiment, the rebate administrator may be configured to allocate and distribute the pharmacy rebate to each pharmacy, based on a portion of the manufacturer rebates. The portion may be the portion of the manufacturer rebates that is attributable to the claims that are received from that pharmacy.

At least some of the claims received by the claims processing subsystem 110 from the pharmacies may originate from one or more parties, i.e. may have been submitted by, or on behalf of, one or more parties. These parties may include, but are not limited to, the following: employees (of one or more employers); consumers (both insured and non-insured); subscribers to a policy; employers; patients; non-prescription insured customers; Medicare recipients; the elderly; and members of organizations.

The rebate subsystem 120 may allocate and distribute a rebate to each of the parties. Each rebate distributed to a party may be computed based on a portion of the manufacturer rebates. In some embodiments, each rebate distributed to a party may be computed based on the portion of the manufacturer rebates that is attributable to the claims that have been submitted by, or on behalf of, the party. The RPPM may distribute the rebates based on the portion of the claim(s) that is attributable to what the respective parties/entities paid. For example, the rebate subsystem 120 may allocate a pharmacy chain's rebates to one sub-category, an employer's rebates to another sub-category, the employees' rebates to another subcategory, a non-insured consumer's rebates (or a rebate for the elderly) to another subcategory, and charity rebates to yet another subcategory. In other words, the rebate subsystem 120 sorts the received claims by sub-groups.

The rebate subsystem 120 may be configured to monitor the dollar amount and percent a party or entity contributes to a specific claim (or claims), i.e. the percentage of the claim (or claims) that the party/entity paid for, as well as the total dollar amount or percentage the individual parties/entities contribute to the total claims stored and processed in the RPPM system. The party or entity may include, but is not limited to, the following: a pharmacy; a pharmacy's headquarters; an employer or other type of company; a wholesaler; a patient; and a consumer.

The rebates distributed to individual consumers (both insured and non-insured), or patients, or to any other type of drug purchasers may include, but are not limited to, one or more of the following: pharmacy coupons; pharmacy credits; pharmacy cash refunds; non-pharmacy store coupons; pharmacy points or miles; airline miles; and club card credits. By paying out the rebates to the individual pharmacies, pharmacy headquarters, employers, etc., and by distributing the rebates to the individual consumers and customers in the various forms listed above, the RPPM system is able to substantially lower prescription costs for all consumers, employees, and employers.

In some embodiments, the allocation and distribution of rebates to the individual parties (consumers, customers, subscribers, patients, etc.) may occur at the pharmacies themselves (either at the individual pharmacies, or at a pharmacy chain headquarters). In these embodiments, each pharmacy (or pharmacy chain headquarters) may have a processing system (not shown) configured to allocate and distribute a rebate to each of the individual parties, based on the portion of the manufacturer rebates that is attributable to the claim(s) that are received on behalf of that party.

The distribution of rebates to the point of sale level in the RPPM system occurs through a flow of the rebates down the pharmacy chain, as a result of which the public (including but not limited to consumers, employees etc.) is able to receive their prescriptions and rebates in many different forms (including but not limited to credits, cash refunds, gift certificates, and free merchandise). The rebates may be monitored by both the rebate recipient and the rebate provider, in a way similar to the monitoring of airline miles. The monitoring may be performed through one or more RPPM websites, for example the “drugbenefitfund” website in America. Such websites may keep a running total of rebates that are due to each entity or consumer. The rebates due to each entity or consumer may be monitored through these websites, which may show the total amount of rebates due based on the total claims processed as well as the percentage that is attributable to that entity or consumer.

In one embodiment, the system 100 may further include a reporting subsystem 130 configured to post information about the rebates on a website. For example, the reporting subsystem 130 may be connected to one or more websites via the internet 132, as illustrated in FIG. 1. The reporting subsystem 130 may receive a request at the website from a pharmacy about the pharmacy rebate that is delivered to that pharmacy, and may provide information from the website to that pharmacy about the pharmacy rebate that is delivered to that pharmacy, in response to the request. The reporting subsystem 130 may also receive a request at the website from a party (consumer, employee, employer, etc.) about the rebate that is delivered to that party. The reporting subsystem 130 may and provide, in response to the request, information from the website to that party about the rebate that is delivered to that party. In one embodiment, the reporting subsystem 130 may deliver periodic statements to each of the pharmacies about the pharmacy rebate that is delivered to that pharmacy.

In one embodiment, the rebate subsystem 120 may distribute the pharmacy rebate by electronic transfer of funds, for faster payment and less loss in interest. The rebates may, for example, be distributed and transmitted through an ATM/Debit type transaction. In the case of insured or non-insured consumers, their registered discount or benefits card may be electronically transmitted from their pharmacy to the RPPM network. The resulting quicker payment and reimbursement would result in less interest loss for the pharmacies. Such electronic funds transfer may impact savings quite dramatically.

Pricing of Prescriptions Based on Real Cost of Drug Plus Fee

Prescription insurance plans or claims processors, such as PBM's (Prescription Benefit Managers), generally bill employers using the AWP (Average Whole Price) pricing method, which is an industry standard. The AWP method is an escalated pricing method that includes an inherent mark-up in the charges billed to employers and consumers. The AWP may include a very hefty mark-up from the real cost of the drug, and typically ranges between about 30% to about 1000% or higher, compared to the actual acquisition cost that the pharmacy pays to the wholesaler when acquiring a prescription drug, i.e. compared to the real cost of the drug. For convenience, the actual acquisition cost paid by the pharmacy to the wholesaler will hereinafter be referred to as the AC. Typically, the AC is about 10% higher, compared to the actual amount the wholesaler pays the drug company.

In one embodiment of the methods and systems discussed in the present disclosure, the industry standard AWP pricing method, used by current prescription claims processors and other third party groups, is replaced by a formula based on the real cost of the drug (which is the AC or the acquisition cost paid by the pharmacy to the wholesaler), plus fixed fees. For convenience, this formula will hereinafter be referred to as the Cost Plus formula. The Cost Plus formula provides a pricing method for prescription drugs that is based on the real cost of the drug, plus certain fixed fees, instead of marking up the AC in an escalated and arbitrary fashion, as is done when the AWP method is used.

In an embodiment in which an employer has a pharmacy on the premises for employees only, the Cost Plus formula may be given by:
CODS (Cost of Drug Sold)+Fixed Fees=PBC (Prescription Benefit Cost) (1)

In equation (1) above, the term “Cost of Drug Sold” stands for the on-premise pharmacy's real cost for the drug sold. In other words, the is the same as the actual acquisition cost (AC) which is the price paid by the pharmacy to the wholesaler for the drug. The term “Fixed Fees” in equation (1) above may include the following fees: a) a fee for the cost of operating the pharmacy; and b) an RPPM fee. The Prescription Benefit Cost is the total cost to the employee for the prescription benefit. Equation (1) may be equivalently written by spelling out the Fixed Fees term, as follows:
CODS (Cost of Drug Sold)+COOP (Cost of Operating Pharmacy)+RPPM fee=PBC (Prescription Benefit Cost) (1)′

The Cost Plus formula for pricing prescriptions, described above, may be used to decrease prescription benefit costs, by allowing the employer to use a pharmacy on the premises for employees only, then to bill the employee based on the CODS (real cost of drug sold). The Cost Plus formula reduces prescription benefit costs for employers (e.g. corporations), by eliminating the need for an insurance plan such as a PBM, and/or a retail pharmacy, depending on the corporation's or employer's facilities and whether or not they have or want a pharmacy on the premises.

Alternatively, in a situation in which the pharmacy serves not only the employees of a specific employer, but also the general public, the Cost Plus formula may be given as follows:
CODS (Cost of Drug Sold)−(Retail Net Revenue+Copay+Rebates)+COOP (Cost of Operating Pharmacy)+RPPM fee=PBC (Prescription Benefit Cost) with retail net revenue (2)

As seen in Equation (2) above, in this case the CODS (real cost of drug) is reduced by a term that is a sum of: retail net revenue, copay, and rebates. For convenience, the sum of retail net revenue, copy, and rebates may be hereinafter referred to as a term called “Prescription Benefit Cost Reducer.” The difference between CODS and the Prescription Benefit Cost Reducer may be viewed as a net cost of the drugs, which may be given by: Cost of Drug Sold less retail net revenue and less copay and less rebates. Equation (2) may thus be viewed as stating that the net cost of drugs plus fixed fees (cost of operating pharmacy plus RPPM fee) is the PBC with retail net revenue.

In the Cost Plus formula as provided in equation (2), the prescription benefit cost is further reduced (from a sum of the real or actual cost of drugs plus fixed fees) by the retail net revenue of the pharmacy, the copay paid by the customer of the pharmacy (who is also the purchaser of the prescription benefits), and the rebates distributed to the customer by the pharmacy.

The Cost Plus formula as provided in equation (2) reduces prescription benefit costs for employers (e.g. corporations), by eliminating the need for an insurance plan such as PBMs. By eliminating the PBM, the employer is in control of the management of the billings, and is charged much lower fees, compared to what the PBMs would have charged the employer. The employer may hire an accountant who may manage the prescription benefits using the Cost Plus formula, and who may provide the employer with more control over issues such as prescriptions billing fraud and drug diversion.

Employers and/or pharmacies that use the Cost Plus formulas (provided in equations (1), (1)′, and (2) above) may be viewed as acting as their own PBM, since the Cost Plus formulas discussed above eliminate the need for PBMs. Referring back to the system 100 illustrated in FIG. 1, the claims processing subsystem may include an operating system configured to allow the pharmacies and/or employers to act as their own PBM, while at the same time allowing the pharmacies to continue to bill via traditional PBMs, when needed or desired. In other words, while the RPPM system unifies pharmacies and their claims, is still provides options for current prescription benefit providers (i.e. PBMs) to be included in the transmission and processing of prescription claims.

Typically, PBMs bill employers, and pay pharmacies using a formula based PBMs bill employers using the following formulas:
for brand name drugs and some of the more expensive generic drugs, AWP minus from about 14% to about 25% is charged by PBMs;
for generic drugs, AWP minus about 30% is charged by the PBMs;
for very inexpensive generics, PBMs charge the maximum allowable cost of ingredients (“MAC”), times a metric quantity.

Depending on the contract with the individual pharmacies, PBMs may use different formulas to pay pharmacies. For brand name drug, for example, the PBMs may charge the AWP times a metric quantity, minus 15%, plus a dispensing fee. For generic drugs, the PBMs may pay pharmacies an amount given by the MAC (maximum allowable cost of ingredients), times a metric quantity, plus a dispensing fee.

The RPPM system 100 (described in FIG. 1) may be analogous to a single large PBM throughout the US, that uses a prescriptions pricing method that is based on the real cost of the drug, and that gives rebates back to the consumers. The RPPM would achieve maximum capability by aggregating most of the US PBM networks and/or pharmacies, their prescription claims, and the employers originating the claims.

The RPPM system 100 may implement a pricing method based on Cost Plus, using one of the formulas explained above, depending on the particular situation. Alternatively, the RPPM system 100 may implement a pricing method based on subtracting a percentage from the AWP to make the resulting prescription price the same as if Cost Plus had been used. In other words, the RPPM system 100 may reduce prescription costs by using the formula
AWP−X%, (3)
where X is chosen so that the resulting price is equal to the price that would have been obtained using Cost Plus. A certain percentage is subtracted from the heavily marked-up AWP, where the percentage is typically much larger than the 14% to 15% used by PBMs, and in particular is large enough so that the resulting price is equal to the price that would result from a Cost Plus pricing method.

In embodiments in which the RPPM system 100 implements prescription pricing methods based on Cost Plus (equations (1), (1)′, and (2)) and/or “AWP−X%” (equation (3)), the RPPM system 100 may include one or more subsystems and/or processors that are programmed and configured to compute prescription prices using the formulas provided above (equations (1), and/or (1)′, and/or (2), and/or (3)). In these embodiments, the RPPM system 100 may include both computer software and hardware necessary for performing such computations.

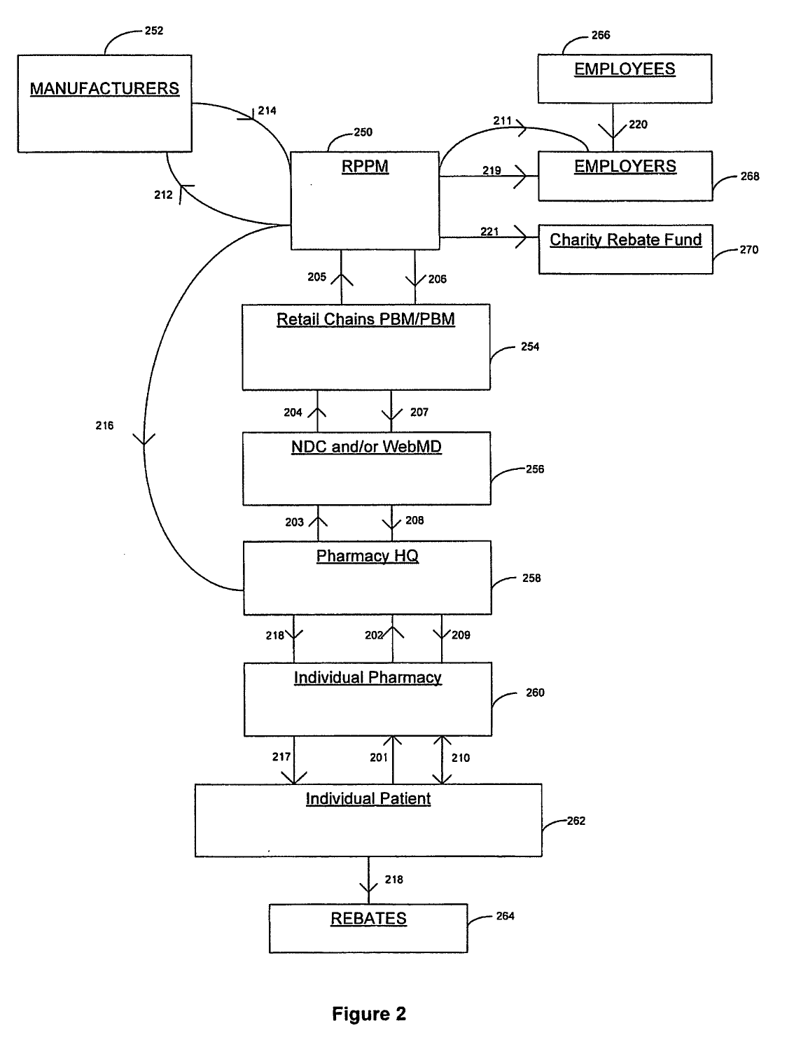

FIG. 2 is a conceptual diagram illustrating a flow of operations that may occur between different entities, in one embodiment of methods and systems in which prescription costs are lowered by aggregating claims and obtaining manufacturer rebates, and by using the Cost Plus pricing method described above.

In the embodiment illustrated in FIG. 2, an RPPM 250 (which in some cases may be an Employer Benefit Fund) allocates the rebates and bills the employer(s) 268, but gives the option to allocate directly via the NDC (and/or WebMD) 256, or directly to the pharmacy headquarters 258. A retail chain PBM 254, or any PBM, may carry out the adjudication of prescription claims, using the Cost Plus pricing method described above, or using AWP−X%, where X is chosen so that the resulting price is the same as the price obtained using Cost Plus. The retail chain PBM 254 then submits the claim to the RPPM network, so that rebate allocation and distribution can be carried out as described in conjunction with FIG. 1.

In initial act 201, in the flow of operations conceptually illustrated in FIG. 2A, an individual patient 262 may bring his prescription into an individual pharmacy 260. The patient 262 may include, but is not limited to, any one of the following: a consumer (either insured or non-insured); a subscription policy holder; an employee or dependent thereof; a non-card holder. In act 202, the pharmacy 260 may transmit the claim through the mainframe at the pharmacy headquarters 258.

In act 203, the claim may pass through a switch company, which may either be the NDC or the WebMD. In act 204, the NDC or the WebMD may route the claim to the designated PBM 254. In act 205, the patient's claim is submitted to the data storage subsystem in the RPPM 250, where claims are aggregated for rebate purposes, and prescription pricing under the Cost Plus method or the AWP−X% method occurs. In act 206, the RPPM 254 may verify eligibility of the transmitted claim for the RPPM aggregation method, and upon satisfactory verification, may request the PBM 254 to report to the pharmacy 260 that the patient is eligible. The RPPM 254 may also read price tables from the PBM transmissions and the pharmacy transmissions. The RPPM 254 may also compute and report any co-pays, rebates, fees, and other formularies that may be applicable to the particular claim from the patient.

In act 207, the PBM 254 may transmit to the pharmacy 258 through the NDC or the WebMD 256 the approval for the patient 262 to receive the drug from the pharmacy 260 for the suggested co-pay. In act 208, the NDC/WebMD may relay this request back to the pharmacy headquarters 258 that sent the original request. In act 209, the claim passes through the pharmacy headquarters 258 to the actual pharmacy 260. In act 210, the claim is logged onto the patient profile of the individual patient 262. A label may be generated, including information such as: the total reimbursement due to the pharmacy; the pharmacy's actual acquisition cost of the drug (AC or equivalently CODS); the RPPM/EBF fee; the patient's co-pay; and the rebate miles and/or points due to the patient and/or the patient's employer, and to the pharmacy, based on the portion of the aggregated claims that is attributable to the claim submitted by the pharmacy, the employer, and the patient, respectively.

In act 211, the RPPM 250 bills the employer 268, using Cost Plus or AWP−X%. In act 212, a rebate subsystem in the RPPM 250 aggregates the claims by manufacturer, and requests are sent to the manufacturers for manufacturer rebates. In act 214, the manufacturers pays the manufacturer rebates to the RPPM 250. In act 216, the manufacturer rebates are allocated to the pertinent parties, then distributed by the rebate subsystem in the RPPM 250 to the pharmacy headquarters 256 and the individual pharmacy 260. In act 217, the rebates received by the individual pharmacy 260 are allocated to each individual patient based on the portion attributable to the claim(s) submitted by the individual patient. In act 218, the rebates are distributed in various forms, including but not limited to: a prescription credit; a store or pharmacy coupon; as store club card (e.g. a VONS card that can be used nationally), and a cash refund.

In act 219, the manufacturer rebates (received from the manufacturers) are allocated to employers, based on the percentage attributable to what the employer paid for that claim. Finally, in act 220 the employers 268 allocate and distribute the rebates to the employees 266, in various forms including but not limited to: increased wages; paid vacations and/or days off; free vacation packages and promotions; free store merchandise; lower co-pays and/or deductibles; and airline tickets. Finally, in act 221, the rebates are distributed to a Charity Rebate Fund.

As can be seen from FIG. 2, the RPPM system and method allows individual pharmacies and the pharmacy headquarters to control the distribution of drugs, instead of PBMs and other the claims processing insurance companies.

FIG. 2 is a conceptual diagram of one illustrative example, only, and in other embodiments of methods and systems in which prescription costs are lowered by aggregating claims, variations may occur in the flow of operations between different entities. For example, the NDC and the WebMD may together form by themselves the RPPM network. At present, the NDC together with the WebMD would constitute a larger market share, compared to any one PBM, and would be able to form a consolidated market share database having a maximum capacity. While NDC and WebMD traditionally have been a hub or center for prescription claims, they have not been aggregated so far for the purpose of USA rebates. In this example, the traditional PBMs would adjudicate the prescription claims (using AWP−X% where X is chosen so that the resulting price is equal to the price that would result from a Cost Plus pricing method), while the NDC and the WebMD would carry out rebate allocation.

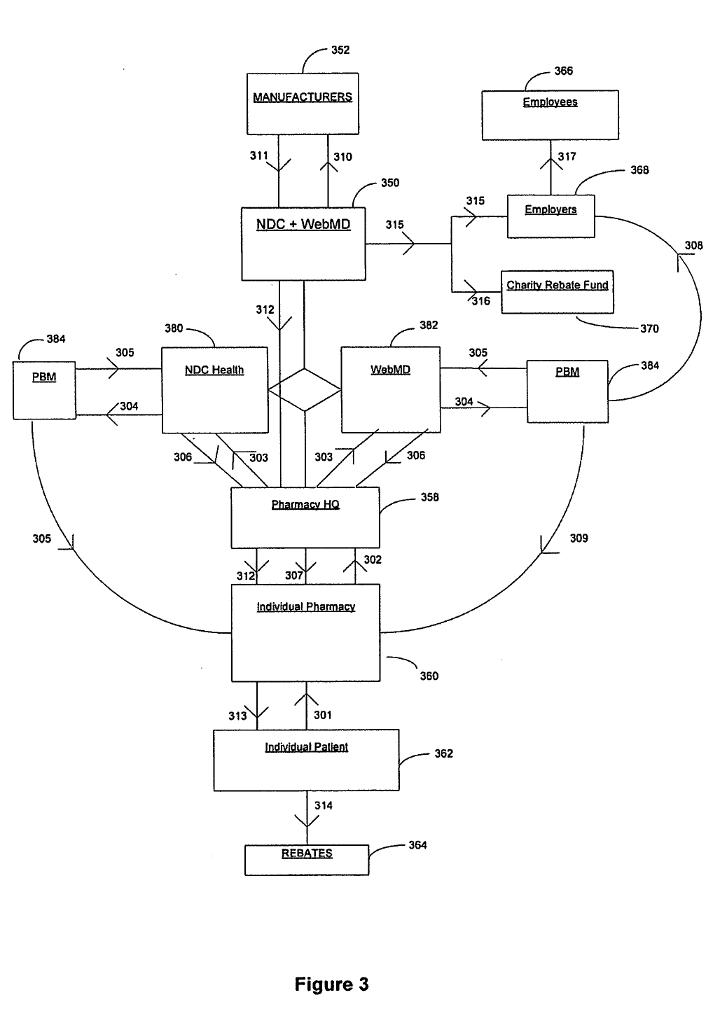

FIG. 3 illustrates a conceptual diagram illustrating a flow of operations that may occur between different entities, in an embodiment in which the NDC and the WebMD together form the RPPM system and network itself. In the embodiment illustrated in FIG. 3, the patient 362 may bring his prescription claim into an individual pharmacy 360, in initial act 301. The prescription claim of the patient 362 may be submitted by, or on behalf of, the patient. The pharmacy 360 may transmit the claim through the mainframe at the pharmacy HQ (headquarters) 358, in act 302. In act 304, the NDC 380 or the WebMD 382 routes the claim to the designated PBM 384 for adjudication of the claim.

In act 305, the PBM 384 transmits, through the NDC 380 or the WebMD 382, the approval for the patient 362 to receive the drug from the pharmacy 360 for the suggested co-pay. In act 306, the NDC or the WebMD relays this request back to the pharmacy headquarters 358 that sent the original request. In act 307, the claim passes through the pharmacy headquarters 358 to the individual pharmacy 360. The claim is then logged onto the patient profile of the individual patient 262. A label may be generated, including information such as the total reimbursement due to the pharmacy, the pharmacy's actual acquisition cost of the drug (AC or equivalently CODS); the RPPM/EBF fee; the patient's co-pay; and the rebate miles and/or points due to the patient and/or the patient's employer, and to the pharmacy, based on the portion of the aggregated claims that is attributable to the respective claim(s) submitted by the pharmacy, the employer, and the patient.

In act 308, the PBM 384 bills the employer 268, using Cost Plus or AWP−X%. (Note that in the embodiment illustrated in FIG. 2A, the RPPM 250 billed the employer). In act 309, the PBM 384 pays the pharmacy HQ 358 and the individual pharmacy 360 the amount due that was computed using the Cost Plus method. In act 310, the RPPM (i.e. the NDCAWebMD 350) claims are aggregated by manufacturer, and requests are sent to the manufacturers for manufacturer rebates. In act 31 1, the manufacturers transfers the manufacturer rebates to the RPPM system and account. In act 312, the RPPM 350 allocates the manufacturer rebates to the pertinent parties, then distributed to the pharmacy headquarters 358 and the individual pharmacy 360. In act 313, the rebates are allocated to each individual patient based on the portion attributable to the claim(s) submitted by the individual patient. In act 314, the rebates are distributed in various forms, as explained above in connection with FIG. 2A.

In act 315, the manufacturer rebates are allocated to employers, based on the percentage attributable to what the employer paid for that claim. In act 316, the rebates are allocated to a charity fund. Finally, in act 317 the employers 368 allocate and distribute the rebates to the employees 366, in various forms discussed above in connection with FIG. 2.

Incorporation of Projected Rebates Into the Wholesale Acquisition Cost

In one embodiment of the methods and systems described in the present disclosure, the RPPM System 100 (shown in FIG. 1) estimates the rebates that will be paid by manufacturers to prescription benefit providers (PBMs), in order to eliminate these manufacturer rebates and incorporating them directly into the industry's current WAC (Wholesale Acquisition Cost) price. This is an alternative way of allowing the pharmacies, wholesalers, employers, consumers, and other parties to benefit from the increased manufacturer rebates that result from the aggregation of prescription claims made possible by the RPPM system 100. The amount of discount applied to the WAC typically varies for each entity (e.g. individual pharmacy or pharmacy headquarters), and is influenced by the amount of drug purchases by the entity.

In this embodiment, the WAC (wholesale acquisition cost) of all manufacturer drugs are lowered, by projecting the amount of rebates that will be incorporated into the pharmacy's or wholesaler's drug cost. For brand name drugs, the total dollar amount of rebates that will be incorporated into each individual drug cost may be determined by aggregating the total number of prescriptions from a specific manufacturer, times the average brand prescription price (which in many cases may range from about $100 to about $110), times the average claims processing rebates that PBMs typically pay (which in many cases may range from about 10% to about 15%). The resulting sum will hereinafter be referred to as a Projected Rebate Sum (PRS).

The pricing system and method based on PRS (Projected Rebate Sum), described above, may allow manufacturers to reduce drug cost overall for wholesalers and pharmacies, reducing the drug cost by an amount attributable to the number of drugs or claims that an entity purchased or processed. In the PRS method, the individual drug cost for each entity may vary, based on the amount of claims processed for each entity. For example, some pharmacies that have a larger market share may have lower costs (i.e. lower WAC) than other pharmacies that have a smaller market share.

The PRS pricing method may provide an incentive for entities such as state or local government offices, or even the federal government, to buy drugs in bulk using the RPPM system and the PRS pricing method described above. By using these methods, drug wholesalers and national pharmacy chains that buy and process billions of prescriptions would incur much lower drug costs compared to what they currently incur. than they are today (WAC-4-6%). Even wholesalers' bulk discounts would increase.

In an embodiment of the RPPM system in which the PRS method is used, the RPPM system may include a PRS (Projected Rebate Sum) subsystem (not shown). The PRS subsystem may be configured to aggregate the drug sales of a drug manufacturer, then multiply by the current assigned AWP (Average Wholesale Price) price, thus generating a total average wholesale price for all of the manufacturer's drug sales. For convenience, the total sum of all of a manufacturer's drug (or product) sales will hereinafter be represented by the acronym MPS-sum, and the total average wholesale price for the MPS-sum will hereinafter be represented by the acronym AWP-sum. The PRS subsystem may further be configured to multiply the MPS-sum by 15%, to obtain the PRS (Projected Rebate Sum).

The PRS method can thus be represented by the following formula:
PRS (Projected Rebate Sum)=(MPS-sum)×(AWP sum)×15% , (4)
where MPS-sum stands for the total sum of all of a manufacturer's product sales, and AWP-sum stands for the total average wholesale price for the MPS-sum For convenience, the difference between the sum of the assigned wholesale acquisition cost for a manufacturer, and the PRS for that manufacturer, may be referred to as the Incorporated Rebate Cost (IRC). Also for convenience, the difference between the WAC (wholesale acquisition cost), and a sum of PRS plus bulk buying rebates, will be referred to as the Rebate Coalition Factor (RCF).

The PRS subsystem may also be placed in any entity, not just in the RPPM. For example, drug manufacturers may have a PRS subsystem, which would allow the manufacturers to project how much would be paid in market share rebates and formulary rebates, with respect to the number of prescription claims that have been processed.

An alternative formulation of the PRS (Projected Rebate Sum) is the total amount of manufacturer claims times the Average wholesale Price (AWP), minus 10%-15% rebates. When viewed in this way, the PRS pricing method can be seen as lowering drug costs by eliminating rebates for insurance companies, such rebates being undeserved because not based on the amount of purchase of the pertinent drug. The PRS pricing method can be seen as rewarding the parties or entities that actually purchase the drugs, including but not limited to pharmacies, employers, wholesalers and consumers.

The PRS subsystem and pricing method allow manufacturers to avoid paying market share and/or formulary rebates, by incorporating these rebates into the current WAC (Wholesale Acquisition Cost) for each drug during pre-sale. The PRS subsystem allows manufacturers to avoid paying rebates to claims processing companies or insurance companies, such as the PBMs.

By using the PRS (Projected Rebate Sum) subsystem, drug companies and manufacturers may be able to incorporate claims processing rebates (which typically had been paid out by the manufacturers to the PBMs) and other fees, as well large bulk discounts resulting from bulk purchases by pharmacies and/or employers, directly into the wholesale acquisition cost (WAC) of the drug. As a result, drug costs would be lowered between about 25% and about 50%, depending what how many pharmacies and how many corporations/employers are members of the RPPM system and network.

Individual Drug Benefit Plans Implemented by Individual Pharmacies/Employers

In another embodiment of the systems and methods described in the present disclosure, prescription costs may be lowered by allowing individual pharmacies and/or employers to implement their own “in-house drug benefit programs,” in competition with outside benefit plans. In this embodiment, pharmacy chains, or individual pharmacies, which usually use an outside claims processing company (typically a PBM) may transmit and process claims within their own company network, to avoid un-necessary processing fees, while increasing their revenue and bottom line profits. They may incorporate an in-house RPPM database, or use a pre-existing PBM system, to process the prescription claims for their own employees processing, and to collectively aggregate their in-house claim. They may connect and transmit these in-house claims to a central RPPM network or node within which multiple pharmacies and pharmacy chains are connected, thereby allowing each pharmacy or pharmacy chain headquarters to collectively maximize their market share, performance, or other formulary rebates.

In this embodiment, the in-house drug benefit plans described above may also have the option of catering to the claims processing needs of employees of other pharmacies and/or pharmacy chains, for an additional fee. As a simple example, the Safeway In-House Drug Benefit Program may provide for it's own employees at all Safeway's for an extremely low co-pay. If a Safeway employee lives far away from a Safeway Company Store, however, then that employee may have the option of using an Albertson's Pharmacy to process his prescription claims, by paying an additional fee. This option makes is possible for each individual pharmacy and/or pharmacy chain and/or employer to compete with outside prescription claims providers, by providing incentives to their employees to process their prescription claims in-house, rather than seeking outside prescription claims providers, which may be a competitor of the in-house drug benefit plans.

When pharmacies and/or pharmacy headquarters act as their own PBM for employers using their own in-house drug benefit program (primarily designed for their own employees), as described above, they may be able to control the distribution of drugs. They may also be able to generate and receive larger market share rebates from a centralized RPPM node that connects to many in-house pharmacies or RPPM node-subsystems of many entities. This would result in lower drug prices overall, for the USA.

In this embodiment, the RPPM system may review each prescription claim to determine whether or not an employee is seeking an outside prescription claims provider (for example a competitor of the employer's in-house pharmacy provider), and to charge the employee a higher co-pay when employees are seeking an outside prescription claims provider rather than the in-house pharmacy provider.

The RPPM system and network, or the NDC or/and WebMD's networks and systems that are performing as the RPPM (see FIG. 3), may route prescription claims based on an incoming request from the pharmacies, using a specific carrier code and plan name, for the purpose of determining if the claim seeks an out-sourced prescription claims provider (and thus a higher co-pay should be charged), or if the claim is in-house, and identifying the proper subtype for each prescription claim. The individual prescription claim submissions may be categorized by carrier code subtype and plan name subtype. The subtypes may include (but are not limited to): 1) the preferred pharmacy provider for that patient; 2) the non-preferred pharmacy provider; and 3) a pre-existing PBM for employers that are not self-insured or not insured by the RPPM.

In this embodiment, the RPPM system 100 (shown in FIG. 1) may include another subsystem (not shown), which may be referred to as a Claims Identification Subsystem (CIS). The CIS (Claims Identification Subsystem) may be configured to allow transmission of claims (from the employees) to the central RPPM system (or to the NDC and/or WebMD that is performing as the RPPM). The CIS may be further configured to divide up the claims into various subtypes or categories, for the purpose of determining the employees co-pay and plan guidelines. For example, the CIS may be configured to determine whether the employee chose to go through an in-house plan, or to a competitor's plan.

Each pharmacy and company may individually and independently compete to provide and contract with other employers/employees. This may allow the drug manufacturers to keep their rebate scheme, while rewarding the proper drug buyers. This may motivate employees to use their own employers drug benefit plan, while still allowing them to use another company's pharmacy and benefit plan for an additional fee, if more convenient.

In this embodiment, each pharmacy is allowed to be a part of a central RPPM Node that connects most pharmacies through their respective in-house RPPM nodes. In this embodiment, drug purchase discounts may increase, for the following reason: the more prescriptions and drugs a given pharmacy or pharmacy headquarters purchases, the greater the discounts for these purchases. The more a person buys, the more discounts he receives. The more prescription claims an employer is able to influence its employees to process for drugs made by a specific manufacturer, the more rebates the employer receives.

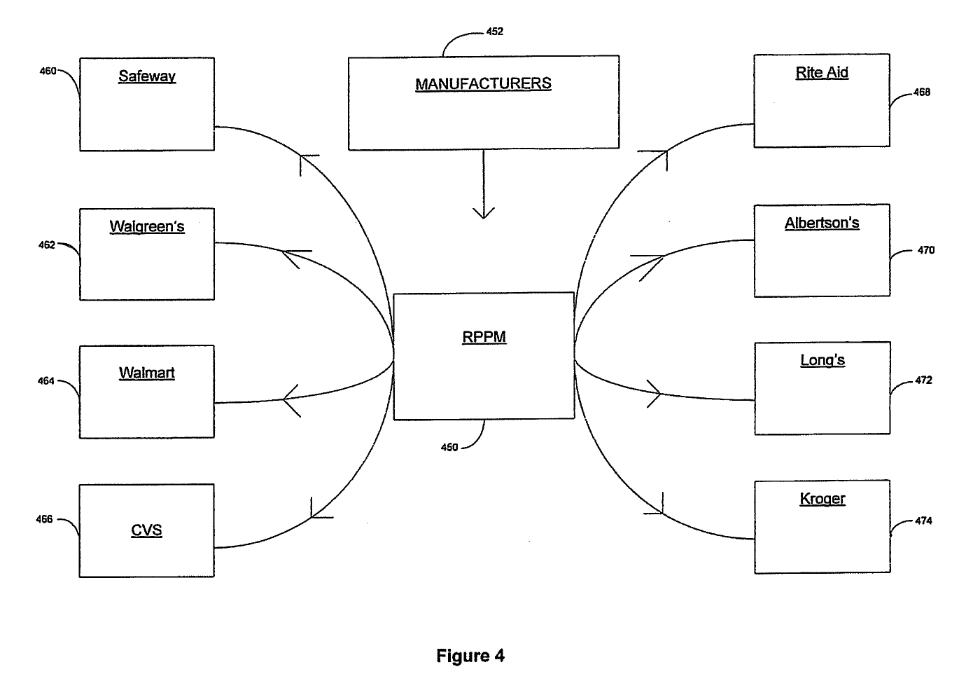

FIG. 4 is a conceptual diagram illustrating a system and method for lowering prescription costs through drug benefit plans implemented by individual pharmacies and/or employers in competition with outside benefit plans. As seen in FIG. 4, the RPPM (which in some embodiments, such as the embodiment illustrated in FIG. 3, may be formed by the NDC together with the WebMD) 450 may be connected to multiple in-house drug benefit plans, through respective in-house RPPM database. In FIG. 4, eight in-house plans are illustrated (Safeway plan 460, Walgreen's plan 462, Walmart plan 464, CVS plan 466, Rite Aid plan 468, Albertson's plan 470, Long's plan 472, and Kroger plan 474), although of course the examples shown are for illustrative purposes only, and many other in-house drug benefit plans may be connected to the RPPM 452.

In the illustrated embodiment, individual pharmacies and their corporate headquarters act as an individual claims processor, influencing and controlling the distribution of drugs by offering the patient rebate incentives, and allowing the physician to have a final say and approval in choosing a prescription drug. Allowing the physician to choose may be a more rational approach, compared to forcing the physician to prescribe a drug just so that some PBM can receive a higher (and undeserved) rebate. Although each of the in-house drug benefit programs shown in FIG. 4 (460-474) competes with each other for employer contracts, they are all part of the central RPPM network 450, and may all provide for each other and each of their contracted employers, with the understanding that an additional co-pay will be charged for going to an outside company's drug benefit plan.

The embodiment illustrated in FIG. 4 allows pharmacies and employers to unify their claims for the purpose of larger market share rebates, while still allowing individual pharmacies (and/or pharmacy HQs) to compete and act as their own drug benefit plan. This allows drug manufacturers to continue to use rebates to promote their products.

The RPPM method described above may be applied in a variety of ways, depending on the circumstances and/or political strengths of the entities involved. The different applications of the RPPM system and method all allow the entities that purchase drugs to pay less, through RPPM computed rebates, as well as through the incorporation of rebates into wholesale acquisition costs. The end result may be greater consumer satisfaction and employee satisfaction, as well as lower overall drug costs incurred by the wholesalers, the employers, and the pharmacies.

Certain embodiments of methods and systems for lowering prescription drug costs have been described. It is to be understood, however, that the concepts implicit in these embodiments may be used in other embodiments as well. The protection of this application is limited solely to the claims that now follow.

In these claims, reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference, and are intended to be encompassed by the claims. Moreover, nothing disclosed herein is intended to be dedicated to the public, regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A system for reducing prescription costs, the system comprising:
a processing system configured to receive and process claims from multiple pharmacies for prescriptions made by multiple manufacturers, the processing system further configured to aggregate the received claims for the prescriptions made by each manufacturer, to obtain from each manufacturer a manufacturer rebate based on the aggregated claims for that manufacturer, and to allocate and distribute a pharmacy rebate to each pharmacy, each pharmacy rebate being based on the portion of the manufacturer rebates that is attributable to the claims that are received from the pharmacy.

2. The system of claim 1,
further comprising a data storage subsystem; and
wherein the processing system is configured to store the received claims in the data storage subsystem.

3. The system of claim 1, wherein at least some of the claims received by the processing system comprise claims submitted by or on behalf of one or more parties, and wherein the processing system is further configured to allocate and distribute a rebate to each of the parties, the rebate for each party being based on the portion of the manufacturer rebates that is attributable to the claims submitted by or on behalf of that party.

4. The system of claim 3,
wherein the parties comprise at least one of:
an employee of an employer;
a non-insured consumer;
an insured consumer;
a non-prescription insured customer;
a patient;
and
a subscriber to a policy.

5. The system of claim 4,
wherein the rebate distributed to at least some of the parties comprises one or more of:
a pharmacy coupon;
a pharmacy credit;
a pharmacy cash refund;
a non-pharmacy store coupon;
pharmacy points or miles;
airline miles; and
club card credits.

6. The system of claim 1, wherein the processing system is further configured to distribute the pharmacy rebate by an electronic transfer of funds.

7. The system of claim 1, wherein the processing system is further configured to obtain a manufacturer rebate by delivering a request to each manufacturer for a manufacturer rebate based on the aggregated claims for that manufacturer, and by receiving a manufacturer rebate from each manufacturer in response to the request to the manufacturer.

8. The system of claim 3, further comprising a reporting subsystem configured to post on a website information about the pharmacy rebate or about the rebate distributed to each party.

9. The system of claim 8, wherein the reporting subsystem is further configured to receive a request at the website from one of the pharmacies about the pharmacy rebate that is delivered to that pharmacy and to provide, in response to the request, information from the website to that pharmacy about the pharmacy rebate that is delivered to that pharmacy; and
wherein the reporting subsystem is further configured to receive a request at the website from one of the parties about the rebate that is delivered to that party and to provide, in response to the request, information from the website to that party about the rebate that is delivered to that party.

10. The system of claim 8, wherein the reporting subsystem is further configured to deliver periodic statements to each of the pharmacies about the pharmacy rebate that is delivered to that pharmacy, and to delivery periodic statements to each of the parties about the rebate that is delivered to that party.

11. The system of claim 2, wherein the processing system comprises:
a rebate aggregator configured to aggregate the claims in the data storage subsystem for the prescriptions made by each manufacturer; and
a rebate administrator configured to deliver a request to each manufacturer for a manufacturer rebate based on the aggregated claims for that manufacturer, to receive a manufacturer rebate from each manufacturer in response to the request to the manufacturer, and to allocate and distribute a pharmacy rebate to each pharmacy, each pharmacy rebate based on the portion of the manufacturer rebates that are attributable to the claims that are received from that pharmacy.

12. A system for reducing prescription costs, the system comprising:
a processing subsystem configured to receive and process, on behalf of multiple employers, claims from multiple pharmacies for prescriptions made by multiple manufacturers, the processing system further configured to aggregate the received claims for the prescriptions made by each manufacturer, to obtain from each manufacturer a manufacturer rebate based on the aggregated claims for that manufacturer, and to distribute a rebate to each employer,
wherein each rebate is allocated based on the portion of the manufacturer rebates that is attributable to the claims that are received on behalf of that employer.

13. The system of claim 12, wherein each employer has one or more employees, and wherein the processing system is further configured to allocate and distribute a rebate to each of the employees, the rebate distributed to each employee being based on the portion of the manufacturer rebates that is attributable to the claims that originate from that employee.

14. The system of claim 13, wherein the rebate distributed to at least some of the employees comprises at least one of:
an increase in wages;
one or more days off;
a paid vacation;
free merchandise;
an airline ticket;
a lower pharmacy co-pay; and
a lower deductible.

15. A system for reducing prescription costs, the system comprising:
means for receiving claims from multiple pharmacies for prescriptions made by multiple manufacturers;
means for storing the received claims;
means for aggregating the claims in the database for the prescriptions made by each manufacturer;
means for obtaining a manufacturer rebate from each manufacturer based on the aggregated claims for that manufacturer;
means for allocating and distributing a pharmacy rebate to each of the pharmacies, each pharmacy rebate based on the portion of the manufacturer rebates that are attributable to the claims that are received from the pharmacy.

16. A system for reducing prescription costs, the system comprising:
a claims processing subsystem configured to receive and process claim information about a first set of claims from multiple pharmacies and about a second set of claims from multiple pharmacies, wherein the first set of claims are for prescriptions made by multiple manufacturers including at least one claim for a prescription made by a first manufacturer, and have been previously received by a first claims processing organization, and wherein the second set of claims are for prescriptions made by multiple manufacturers including at least one claim for a prescription made by the first manufacturer, and have been previously received by a second claims processing organization, the claims processing subsystem comprising:
a rebate subsystem configured to aggregate the claim information for the prescriptions made by each manufacturer, to obtain from each manufacturer a manufacturer rebate based on the aggregated claim information for that manufacturer, and to allocate and distribute a rebate in connection with each of the claims, based on the portion of the manufacturer rebates that is attributable to the claim.

17. The system of claim 16, wherein the claims processing subsystem is configured to receive the claim information from a third claims processing organization.

18. The system of claim 16, wherein at least one of the first and second claims processing organizations comprises a prescription benefit manager.

19. A method of reducing prescription costs, comprising:
receiving claims from multiple pharmacies for prescriptions made by multiple manufacturers;
aggregating the received claims for the prescriptions made by each manufacturer;
obtaining a manufacturer rebate from each manufacturer, based on the aggregated claims for that manufacturer; and
allocating and distributing a pharmacy rebate to each of the pharmacies, each pharmacy rebate being based on the portion of the manufacturer rebates that are attributable to the claims that are received from the pharmacy.

20. The method of claim 19,
wherein the act of receiving the claims from multiple pharmacies comprises the act of receiving at least some claims that originate from one or more parties, and
further comprising the act of allocating and distributing a rebate to each of the parties, based on the percentage of the manufacturer rebates that are attributable to the claims that originate from that party.

21. The method of claim 20,
wherein the parties comprise at least one of:
an employee of an employer;
a non-insured consumer;
an insured consumer;
a non-prescription insured customer;
a patient;
an employer;
and
a subscriber to a policy.

22. A system for reducing prescription costs, the system comprising:
a processing system configured to receive and process claims from multiple pharmacies for prescriptions made by multiple manufacturers, the processing system further configured to aggregate the received claims for the prescriptions made by each manufacturer, to obtain from each manufacturer a manufacturer rebate based on the aggregated claims for that manufacturer, and to allocate and distribute a pharmacy rebate to each pharmacy, each pharmacy rebate being based on a portion of the manufacturer rebates.

23. A system for reducing prescription costs, the system comprising:
a processing system configured to receive and process claims from multiple parties for prescriptions made by multiple manufacturers, the processing system further configured to aggregate the received claims for the prescriptions made by each manufacturer, to obtain from each manufacturer a manufacturer rebate based on the aggregated claims for that manufacturer, and to allocate and distribute a rebate to each party, each rebate being based on a portion of the manufacturer rebates.

24. The system of claim 23,
wherein the parties comprise at least one of:
an employee of an employer;
a non-insured consumer;
an insured consumer;
a non-prescription insured customer;
a patient;
an employer;
and
a subscriber to a policy.

25. The system of claim 23, wherein each rebate distributed to each party is based on the portion of the manufacturer rebates that is attributable to the claims that are received from that party.
